(19) United States
(12) Patent Application Publication
(10) Pub. No.: US 2026/0079679 A1
(43) Pub. Date: Mar. 19, 2026

(54) METHOD, APPARATUS, DEVICE, AND MEDIUM FOR PROCESSING A USER PAGE

(71) Applicant: Beijing Zitiao Network Technology Co., Ltd., Beijing (CN)

(72) Inventors: Shengyao Wang, Beijing (CN); Wen Zhang, Beijing (CN); Qiang Li, Beijing (CN); Tao Hu, Beijing (CN); Min Li, Beijing (CN); Zhi Li, Beijing (CN)

(21) Appl. No.: 19/327,742

(22) Filed: Sep. 12, 2025

(30) Foreign Application Priority Data
Sep. 13, 2024 (WO) PCT/CN2024/118935

(51) Int. Cl. G06F 8/38; G06F 3/04842; G06F 8/71

(52) U.S. Cl. CPC G06F 8/38; G06F 3/04842; G06F 8/71

(57) ABSTRACT

A method, an apparatus, a device, and a medium for processing a user page are provided. In the method, a processing request represented in a natural language is received, and the processing request is configured to perform a first action on a first page element in a group of page elements in the user page. A repository is obtained. The repository includes a group of actions performed on the group of page elements and an association between code data for performing the group of actions, and the group of actions includes the first action. Based on the processing request and the repository, first code data for performing the first action on the first page element is determined.

### CROSS REFERENCE

The present application claims priority to International Patent Application No. PCT/CN2024/118935, filed on Sep. 13, 2024 and entitled “METHOD, APPARATUS, DEVICE, AND MEDIUM FOR PROCESSING A USER PAGE”, the entirety of which is incorporated herein by reference.

### FIELD

Example implementations of the present disclosure generally relate to computer technologies, and in particular, to a method, an apparatus, a device, and a computer-readable storage medium for processing a user page.

### BACKGROUND

A client user interface (UI) automated testing is an automated testing means for implementing automatic operation and verification in a form of code by simulating a manner of manually operating an application UI. A page object (PO) mode is a commonly used design mode of a UI automated testing. The function is to use each page in an application as a page object class, use control positioning information in a page as a variable of an object, and encapsulate a UI operation of a page into an object member method, thereby separating a representation (page object) of a page from a test logic (test step code). However, the quality of the test code generated by the prior art is not satisfactory.

### SUMMARY

In a first aspect of the present disclosure, a method for processing a user page is provided. In the method, a processing request represented in a natural language is received. The processing request is configured to perform a first action on a first page element in a group of page elements in the user page. A repository is obtained. The repository comprises a group of actions performed on the group of page elements and an association between code data for performing the group of actions, and the group of actions comprises the first action. First code data for performing the first action on the first page element is determined based on the processing request and the repository.

In a second aspect of the present disclosure, an apparatus for processing a user page is provided. The apparatus comprises a processing request receiving module, configured to receive a processing request represented in a natural language, the processing request being configured to perform a first action on a first page element in a group of page elements in the user page; a repository obtaining module, configured to obtain a repository, the repository comprises a group of actions performed on the group of page elements and an association between code data for performing the group of actions, and the group of actions comprising the first action; and a first code data determining module, configured to determine, based on the processing request and the repository, first code data for performing the first action on the first page element.

In a third aspect of the present disclosure, an electronic device is provided. The electronic device comprises: at least one processing unit; and at least one memory coupled to the at least one processing unit and storing instructions for execution by the at least one processing unit, the instructions, when executed by the at least one processing unit, causing the electronic device to perform the method of the first aspect of the present disclosure.

In a fourth aspect of the present disclosure, there is provided a computer-readable storage medium having stored thereon a computer program which, when executed by a processor, causes the processor to implement the method of the first aspect of the present disclosure.

In a fifth aspect of the present disclosure, there is provided a computer program product, comprising a computer program, wherein the computer program, when executed by a processor, implements the method of the first aspect of the present disclosure.

It should be understood that the summary described in this disclosure is not intended to limit key features or important features of implementations of the present disclosure, nor is it intended to limit the scope of the present disclosure. Other features of the present disclosure will become readily understood from the following description.

### BRIEF DESCRIPTION OF DRAWINGS

The above and other features, advantages, and aspects of the various implementations of the present disclosure will become more apparent from the following detailed description taken in combination with the accompanying drawings. In the drawings, the same or similar reference numbers refer to the same or similar elements, wherein:

FIG. 1 illustrates a schematic diagram of an example environment in which implementations of the present disclosure can be implemented;

FIG. 2 illustrates a schematic diagram for testing a user page according to some example implementations of the present disclosure;

FIG. 3 illustrates a schematic diagram of a process of constructing a repository according to some implementations of the present disclosure;

FIG. 4 illustrates a flowchart of a process of applying a group of labels to original code data to obtain labeled code data according to some implementations of the present disclosure;

FIG. 5 illustrates a schematic diagram of an example of standardized code data according to some implementations of the present disclosure;

FIG. 6 illustrates a schematic diagram of a process of obtaining first code data from a repository according to some implementations of the present disclosure;

FIG. 7 illustrates a flowchart of a method of testing a user page according to some implementations of the present disclosure;

FIG. 8 illustrates a block diagram of an apparatus for testing a user page according to some implementations of the present disclosure; and

FIG. 9 illustrates a block diagram of a device capable of implementing various implementations of the present disclosure.

### DETAILED DESCRIPTION

Implementations of the present disclosure will be described in more detail below with reference to the accompanying drawings. While certain implementations of the present disclosure are shown in the accompanying drawings, it should be understood that the present disclosure may be implemented in various forms and should not be construed as limited to the implementations set forth herein, but rather, these implementations are provided for a more thorough and complete understanding of the present disclosure. It should be understood that the drawings and implementations of the present disclosure are for illustrative purposes only and are not intended to limit the scope of the present disclosure.

In the description of implementations of the present disclosure, the terms “include”, “comprise” and similar terms should be understood to mean open-ended inclusion, that is, “including but not limited to” and “comprising but not limited to”. The term “based on” should be understood as “based at least in part on”. The terms “one implementation” or “the implementation” should be understood as “at least one implementation”. The term “some implementations” should be understood as “at least some implementations”. Other explicit and implicit definitions may also be included below. As used herein, the term “model” may represent an association between various data. For example, the association may be obtained based on various technical solutions currently known and/or to be developed in the future.

It may be understood that the data involved in the present solution (including but not limited to the data itself, the acquisition or use of the data) shall follow the requirements of the corresponding laws and regulations and related provisions.

It can be understood that, before the solutions disclosed in the implementations of the present disclosure are used, the types of personal information, the usage scope, the usage scenario, and the like related to the present disclosure shall be notified to the user in an appropriate manner according to the relevant laws and regulations and obtain the authorization of the user.

For example, in response to receiving an active request from a user, prompt information is sent to the user to explicitly prompt the user that the requested operation will need to obtain and use the personal information of the user. Therefore, the user may independently choose whether to provide personal information to software or hardware such as an electronic device, an application, a server, or a storage medium that performs the operation of the solution of the present disclosure according to the prompt information.

As an optional but non-limiting implementation, in response to receiving an active request from a user, a manner of sending prompt information to the user may be, for example, a pop-up window, and the prompt information may be presented in a text manner in the pop-up window. In addition, the pop-up window may further carry a selection control for the user to select “agree” or “not agree” to provide personal information to the electronic device.

It may be understood that the foregoing process of notification and obtaining a user authorization is merely illustrative and does not constitute a limitation on implementations of the present disclosure, and other manners of meeting related laws and regulations may also be applied to implementations of the present disclosure.

The term “in response to” as used herein means a state in which a corresponding event occurs or condition is satisfied. It will be appreciated that the timing of execution of a subsequent action performed in response to the event or condition is not necessarily strongly correlated with the time at which the event occurs or the condition holds. For example, in some cases, subsequent actions may be performed immediately when an event occurs or a condition holds; while in other cases, subsequent actions may be performed until a period of time after an event occurs or a condition holds.

### Example Environment

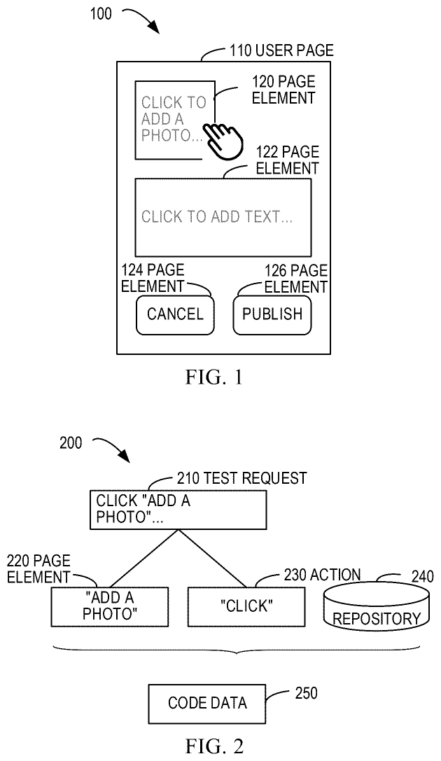

For ease of description, UI automated testing is described with reference to the environment of FIG. 1 as an example. FIG. 1 illustrates a schematic diagram of an example environment 100 in which implementations of the present disclosure can be implemented. In the example environment 100, a user page 110 includes a page element 120 (for example, a control to add a photo), a page element 122 (for example, a control to add text), a page element 124 (for example, a cancel button), and a page element 126 (for example, a publishing button).

In order to test the function of the user page 110, an action needs to be performed on a corresponding page element in the user page 110. For example, to test the publishing function of the user page 110, the page element 126 may be clicked to determine whether a defect exists in the publishing function. A conventional UI automated testing tool may record an action performed on the page element in the user page 110, and the conventional UI automated testing tool may generate test code based on the recorded action.

However, the generated test code has problems such as low quality, poor readability, poor maintainability, and the like, and usually requires manual secondary modification by a tester. In addition, the compilation of the test code usually requires following the operating steps in the test cases. The tester needs to check and understand page objects, elements, and method codes involved in the use cases, and then invoke them one by one and assemble them into the required step code. This requires the tester to have certain code writing capabilities and code understanding capabilities, which is also a time-consuming task. In such cases, it is desirable for a simpler and efficient way to test a user page.

### Overview of Testing a User Page

In order to at least partially remove the drawbacks in the prior art, according to an example implementation of the present disclosure, a method of testing a user page is provided. In the field of testing, the semantic understanding capabilities and code generation capabilities of machine learning models (for example, language models) facilitate the development of testing. The present disclosure proposes the application of a machine learning model to generate UI automated testing code, which not only allows for the rapid generation of corresponding code based on the input natural language but also enhances the readability of the generated code.

Refer to FIG. 2 for an overview of an example implementation according to the present disclosure. FIG. 2 illustrates a schematic diagram 200 for testing a user page according to some example implementations of the present disclosure. As shown in FIG. 2, a test request 210 represented in a natural language (for example, click an “add photo” control) is received. The test request 210 is configured to perform a first action 230 (for example, a click action) on a first page element 220 (for example, an “add a photo” control) in a group of page elements in the user page.

A repository 240 is obtained. The repository comprises a group of actions performed on the group of page elements and an association between code data for performing the group of actions, and the group of actions comprises the first action 230. Based on the test request 210 and the repository 240, first code data 250 for performing the first action 230 on the first page element 220 is determined. The repository 240 may store code required to perform a plurality of actions, which is written in a standardized manner. For example, the repository 240 stores code data 1 corresponding to an action of clicking an “add an image” control and code data 2 corresponding to an action of clicking an “add text” control. Alternatively, and/or in addition, the repository 240 may further store code data corresponding to actions of clicking the page elements 124 and 126.

With the example implementation of the present disclosure, by inputting the test request represented in the natural language, the corresponding code data for testing written in a standardized manner may be determined in the repository. In this way, the threshold for testers to code the test code can be reduced, and the workload for testers in coding and maintaining the test code is reduced.

### Detailed Procedure for Testing a User Page

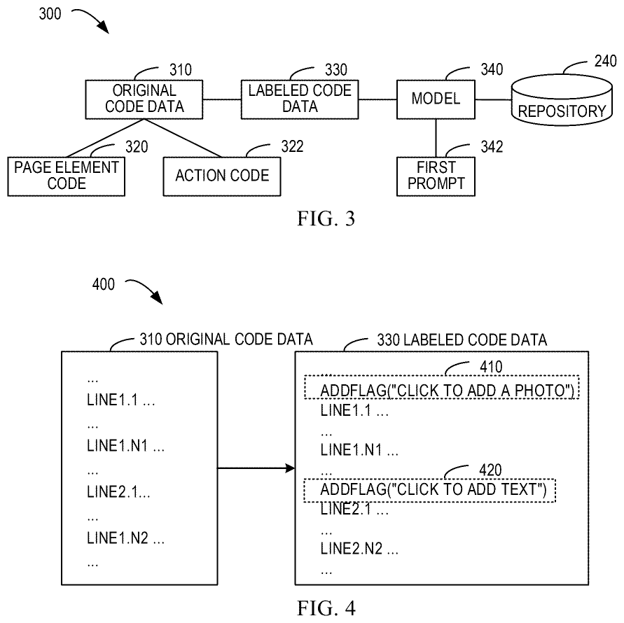

In some example implementations, the repository 240 may be constructed based on original code data generated by a conventional UI automated testing tool. The construction of the repository 240 is described below with reference to FIG. 3, which illustrates a schematic diagram of a process 300 of constructing the repository 240 according to some implementations of the present disclosure. In the process 300, original code data 310 is first obtained, which is obtained by performing an action in the group of actions on a page element in the group of page elements.

The original code data 310 may include page element code 320 and action code 322. The action performed on the page element may include a single click, a double click, an input, a slide, a long press, and the like. In an example, an action performed on the page element may be recorded using a conventional UI automated testing tool, and the original code data may be generated based on the recorded action. During the recording action, all actions performed on all the page elements need to be covered as much as possible. For example, there are 4 page elements in a user page, and 3 actions can be performed. In the process of recording, the 3 actions can be performed on each of the 4 page elements to ensure the integrity of the original code data.

After obtaining the original code data 310, a group of labels may be determined. A label in the group of labels is configured to indicate a code segment associated with the action in the original code data 310. Labeled code data 330 may be obtained by applying the group of labels to the original code data 310. In an example, a group of labels may be manually labeled. Alternatively, and/or in addition, the location of the group of labels may be determined by searching for a predetermined keyword in the code data 310, and then corresponding labels are added accordingly.

Hereinafter, the labeled code data 330 will be described with reference to FIG. 4, which illustrates a flowchart of a process 400 of applying a group of labels to the original code data 310 to obtain the labeled code data 330 according to some implementations of the present disclosure. As shown in the process 400, the original code data 310 may include a plurality of lines of code. The labeled code data 330 may be obtained by applying a group of labels (for example, a label 410 and a label 420) to the original code data 310. The label 410 and the label 420 may be considered as identifiers of a code segment of an action performed on the page element. For example, the code segment between the label 410 and the label 420 corresponds to performing a click action on the “add a photo” control. Take the label 410 as an example, although the label 410 is named ADDFLAG (“CLICK TO ADD A PHOTO”), it may also have other names, such as SETANNOTATION (“CLICK TO ADD A PHOTO”), which is not limited in the present disclosure.

With continued reference to FIG. 3, after the original code data 310 and the group of labels are obtained, code data may be generated based on both. The original code data 310 may have problems such as lack of conciseness, existence of redundant code, poor readability, and poor maintainability. Based on the group of labels, the original code data 310 may be rewritten to eliminate redundant code. With the example implementation of the present disclosure, the original code data with lower quality may be rewritten based on the group of labels, so that code data for testing written in a standardized manner may be generated.

In some example implementations, a first prompt 342 may be constructed. The first prompt 342 may instruct a machine learning model 340 to process the original code data based on the group of labels, to generate the code data. The first prompt will be described below with reference to Table 1. Table 1 shows an example of the first prompt 342.

TABLE 1
An Example Prompt

| | |
|---|---|
| 1. | You are a test engineer who can write UI automated code. |
| | You will get original code |

for a page object and UI operation code for a
corresponding page, where the page UI operation
code is split by the ADDFLAG ( ) function.

| | |
|---|---|
| 2. | Now I give you an example. |
| 3. | The UI operation code of a certain page element is as follows: |
| 4. | ... |
| 5. | The original code of a certain page is as follows: |
| 6. | ... |
| 7. | The code rewritten in a standardized manner is as follows: |

8. ...

As shown in Table 1, the first prompt 342 is text described in a natural language, which may be configured as an input of the machine learning model 340 to instruct the machine learning model to generate content.

After the first prompt 342 is constructed, the code data (which may also be referred to as standardized code data) is determined based on a response of the machine learning model 340 to the first prompt 342. In an example, the input to the machine learning model 340 is the first prompt 342, the labeled code data 330, and the related page element code, and the output of the machine learning model 340 is the standardized page element code and the standardized action code.

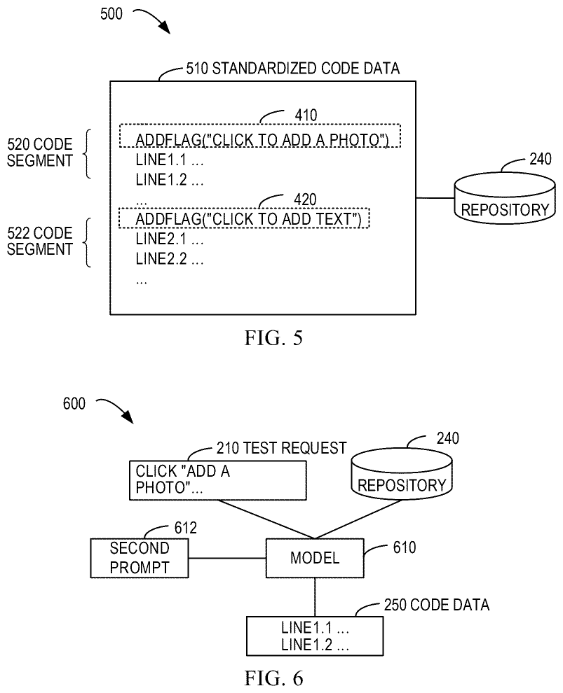

Standardized code data will be described below with reference to FIG. 5, which illustrates a schematic diagram 500 of an example of standardized code data in accordance with some implementations of the present disclosure. As shown in FIG. 5, standardized code data 510 includes a code segment 520 and a code segment 522. Taking the code segment 520 as an example, the code segment 520 starts with a label 410, which is configured to indicate that the code segment 520 corresponds to a click action performed on the “add a photo” control, and the code segment 520 deletes the redundant code in the original code data 310, so that the writing manner of the original code data 310 is more standardized. Upon confirming that the standardized code data 510 generated by the machine learning model 340 meets predetermined criteria, for example, passing redundancy, readability, and maintainability tests, the standardized code data 510 and its corresponding label may be stored in the repository 240 to construct the repository 240.

With the example implementation of the present disclosure, the first prompt provides explicit instruction for the machine learning model, and indicates how the machine learning model generates the code data written in a standardized manner. In this way, the quality of the code data configured for testing output by the machine learning model may be improved, so that the user page can be better tested.

In some example implementations, the first code data includes page element code for describing the user page 110, and action code for describing an action in the group of actions performed on a page element in the group of page elements. The page element code may include positioning information of the page element, encapsulation of a UI operation method, and so on. With the example implementation of the present disclosure, the first code data includes page element code and action code, so that the page object and the action of the test may be separated, thereby improving the reusability and maintainability of the action code.

In some example implementations, page element code corresponding to the user page 110 may be determined, and the first code data matching the page element code and the action may be obtained from the repository 240. Upon receiving the test request, a relevant page may be searched from the repository 240, and a page relationship may be understood according to the label information to obtain the first code data matching the page element code and the standardized first code data of the action. According to the example implementation of the present disclosure, by obtaining matched standardized code data from the repository, the cost of writing code by a tester may be reduced.

Retrieving the first code data from the repository 240 will be described with reference to FIG. 6, which illustrates a schematic diagram of a process 600 of obtaining the first code data from the repository 240 according to some implementations of the present disclosure.

In the process 600, a second prompt 612 may be constructed. The second prompt instructs a machine learning model 610 to retrieve, from the repository 240, code data matching the page element code and the action. The second prompt 612 will be described below with reference to Table 2. Table 2 shows an example of the second prompt 612.

TABLE 2
An Example Prompt

1. You are a test engineer who can write UI automated code.
After a user inputs a test task, the
standardized page code is used to speculate an execution step
path, and corresponding automated
code is written.

After the second prompt 612 is constructed, the first code data may be determined based on a response of the machine learning model 610 to the second prompt 612. The machine learning model 610 may retrieve the first code data 250 in the repository 240 based on the prompt.

With the example implementation of the present disclosure, the second prompt may enable the machine learning model to quickly identify and understand the intention of the task (that is, retrieve the code data matching the page element code and the action), so that the matched and standardized code data may be retrieved, and the test efficiency is improved.

Alternatively, or in addition, in response to a mapping relationship of the page element code, the action (for example, as a key) to the code data (for example, as a value) being stored in the repository 240, the first code data 250 may be retrieved using the manner of the key-value pair retrieval.

In some example implementations, after determining the first code data 250, the first action may be performed on the first page element based on the first code data 250. With the example implementation of the present disclosure, by executing the generated first code data 250, the function and performance of the user page 110 may be tested, thereby ensuring the quality of the application, reducing the maintenance cost, and improving the user experience.

In some example implementations, the user page 110 comprises a first user page and a second user page. The first user page comprises the first page element, and the second user page comprises a second page element. The first page element is configured to trigger a jump from the first user page to the second user page. With the example implementation of the present disclosure, by executing the first code data 250, the page jumping function may be tested to ensure smooth access for users between different pages in the application.

In some example implementations, in response to the first action performed on the first page element, the first user page is jumped to the second user page. After jumping to the second user page, in response to determining that the test request 210 further requests to perform a second action on the second page element, second code data for performing the second action on the second page element is determined based on the test request and the repository, and the second action is performed on the second page element based on the second code data.

For example, the first page element is a control for adding a photo. The second user page pops up after the control for adding a photo is clicked, and a photo may be selected by clicking (as an example of the second action) a control for selecting a photo (as an example of the second control) in the second user page. In response to the test request 210 further requesting to perform a click action on the control for selecting a photo, the second code data for performing the second action on the second page element may be determined, and the second code data is executed to test the second user page. With the example implementation of the present disclosure, by executing the second code data, the function and performance of the jumped page may be tested, thereby ensuring the accessibility of the jumped page.

In some example implementations, the test request 210 is generated based on: for a user page to be tested in a group of user pages in an application, determining a group of page elements in the user page; determining a candidate action to be performed on a page element to be tested in the group of page elements; and generating the test request based on the user page to be tested, the page element to be tested, and the candidate action. After the user page to be tested is obtained, all the page elements to be tested in the user page to be tested may be traversed. The page elements with higher usage frequency may be traversed, or the page elements prone to errors may be traversed to determine which candidate actions may be performed on the element to be tested.

For example, the user page 1 (as an example of the user page to be tested) includes a determining button (as a page element to be tested), and a click action (as an example of the candidate action) may be performed on the determining button. Based on the user page 1, the determining button, and the click operation, an example of the generated test request may be “click the determining button in the user page 1”. With the example implementation of the present disclosure, by inputting the test request written in a natural language, the test code corresponding to the test request may be output by using the semantic understanding and the text generation capability of the machine learning model, thereby reducing the writing cost of the test code.

In some example implementations, to achieve real-time interaction with the machine learning model, a model interaction webpage may be designed based on a developed code library. The labeled code data 330 may be selected on the model interactive webpage, and the labeled action code and the involved page element code are sent to the machine learning model by clicking a sending button to initiate a Hypertext Transfer Protocol (HTTP) request. The machine learning model may return the rewritten page element code and the action code in real-time. In an example, a model dialogue input box may be designed, and by inputting a test task represented in the natural language into the model dialogue input box and the http request being initiated to the model after clicking to send, the model may return the UI automated step code for completing the task in real-time. According to the example implementation of the present disclosure, the test code that is easy to read and easy to maintain can be quickly generated by interacting with the machine learning model through the visualized webpage.

### Example Processes

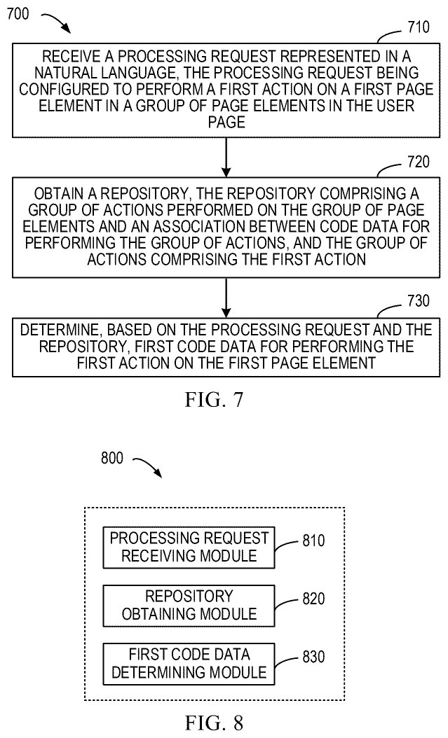

FIG. 7 illustrates a flowchart of a method 700 for testing a user page according to some implementations of the present disclosure. At block 710, a processing request represented in a natural language is received, and the processing request is configured to perform a first action on a first page element in a group of page elements in the user page. At block 720, a repository is obtained. The repository comprises a group of actions performed on the group of page elements and an association between code data for performing the group of actions, and the group of actions comprises the first action. At block 730, based on the processing request and the repository, first code data for performing the first action on the first page element is determined.

In some example implementations, obtaining the repository comprises: obtaining original code data, the original code data being obtained by performing an action in the group of actions on a page element in the group of page elements; determining a group of labels, a label in the group of labels being configured to indicate a code segment associated with the action in the original code data; and generating the code data based on the original code data and the group of labels.

In some example implementations, the first code data comprises: page element code for describing the user page; and action code for describing an action in the group of actions performed on a page element in the group of page elements.

In some example implementations, generating the code data comprises: constructing a first prompt, the first prompt instructs a machine learning model to process the original code data based on the group of labels, to generate the code data; and determining the code data based on a response of the machine learning model to the first prompt.

In some example implementations, determining the first code data comprises: determining a page element code corresponding to the user page; and obtaining, from the repository, the first code data matching the page element code and the action.

In some exemplary implementations, obtaining the first code data from the repository comprises: constructing a second prompt, the second prompt instructing a machine learning model to retrieve, from the repository, code data matching the page element code and the action; and determining the first code data based on a response of the machine learning model to the second prompt.

In some example implementations, the method 700 further comprises performing the first action on the first page element based on the first code data.

In some example implementations, the user page comprises a first user page and a second user page, the first user page comprises the first page element, the second user page comprises a second page element, and the first page element is configured to trigger a jump from the first user page to the second user page.

In some example implementations, the method 700 further comprises: in response to the first action performed on the first page element, jumping from the first user page to the second user page; in response to determining that the processing request further requests to perform a second action on the second page element, determining, based on the processing request and the repository, second code data for performing the second action on the second page element; and performing the second action on the second page element based on the second code data.

In some example implementations, the processing request is generated based on: for a user page to be processed in a group of user pages in an application, determining a group of page elements in the user page; determining a candidate action to be performed on a page element to be processed in the group of page elements; and generating the processing request based on the user page to be processed, the page element to be processed, and the candidate action.

### Example Apparatus and Device

FIG. 8 illustrates a block diagram of an apparatus 800 for processing a user page according to some implementations of the present disclosure. The apparatus 800 comprises a processing request receiving module 810, configured to receive a processing request represented in a natural language, the processing request being configured to perform a first action on a first page element in a group of page elements in the user page; a repository obtaining module 820, configured to obtain a repository, the repository comprises a group of actions performed on the group of page elements and an association between code data for performing the group of actions, and the group of actions comprising the first action; and a first code data determining module 830, configured to determine, based on the processing request and the repository, first code data for performing the first action on the first page element.

In some example implementations, the repository obtaining module 820 is further configured to obtain original code data, the original code data being obtained by performing an action in the group of actions on a page element in the group of page elements; determine a group of labels, a label in the group of labels being configured to indicate a code segment associated with the action in the original code data; and generate the code data based on the original code data and the group of labels.

In some example implementations, the first code data comprises: page element code for describing the user page; and action code for describing an action in the group of actions performed on a page element in the group of page elements.

In some example implementations, the repository obtaining module 820 is further configured to construct a first prompt, the first prompt instructs a machine learning model to process the original code data based on the group of labels, to generate the code data; and determine the code data based on a response of the machine learning model to the first prompt.

In some example implementations, the first code data determining module 830 is further configured to determine a page element code corresponding to the user page; and obtain, from the repository, the first code data matching the page element code and the action.

In some example implementations, the first code data determining module 830 is further configured to construct a second prompt, the second prompt instructing a machine learning model to retrieve, from the repository, code data matching the page element code and the action; and determine the first code data based on a response of the machine learning model to the second prompt.

In some example implementations, the apparatus 800 further comprises a first action performing module configured to perform the first action on the first page element based on the first code data.

In some example implementations, the user page comprises a first user page and a second user page, the first user page comprises the first page element, the second user page comprises a second page element, and the first page element is configured to trigger a jump from the first user page to the second user page.

In some example implementations, the apparatus 800 further comprises a second action performing module configured to, in response to the first action performed on the first page element, jump from the first user page to the second user page; in response to determining that the processing request further requests to perform a second action on the second page element, determine, based on the processing request and the repository, second code data for performing the second action on the second page element; and perform the second action on the second page element based on the second code data.

In some example implementations, the processing request is generated based on: for a user page to be processed in a group of user pages in an application, determining a group of page elements in the user page; determining a candidate action to be performed on a page element to be processed in the group of page elements; and generating the processing request based on the user page to be processed, the page element to be processed, and the candidate action.

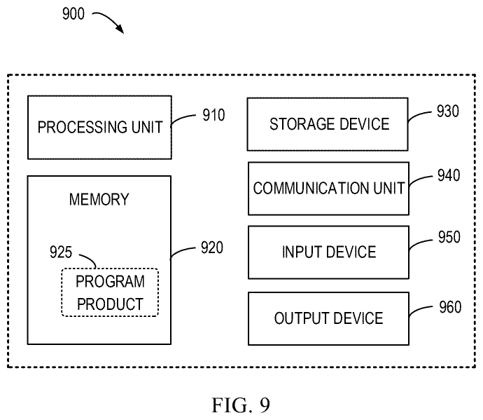

FIG. 9 illustrates a block diagram of a device 900 capable of implementing various implementations of the present disclosure. It should be understood that the computing device 900 shown in FIG. 9 is merely exemplary and should not constitute any limitation on the functionality and scope of the implementations described herein. The computing device 900 shown in FIG. 9 may be configured to implement the method described above.

As shown in FIG. 9, the computing device 900 is in the form of a general-purpose computing device. Components of the computing device 900 may include, but are not limited to, one or more processors or processing units 910, a memory 920, a storage device 930, one or more communication units 940, one or more input devices 950, and one or more output devices 960. The processing unit 910 may be an actual or virtual processor and capable of performing various processes according to programs stored in the memory 920. In multiprocessor systems, multiple processing units perform computer-executable instructions in parallel to improve the parallel processing capabilities of the computing device 900.

The computing device 900 typically includes a plurality of computer storage mediums. Such mediums may be any available medium accessible by the computing device 900, including, but not limited to, volatile and non-volatile medium, removable and non-removable medium. The memory 920 may be a volatile memory (for example, a register, a cache, a random access memory (RAM)), a non-volatile memory (for example, a read-only memory (ROM), an electrically erasable programmable read-only memory (EEPROM), a flash memory), or some combination thereof. The storage device 930 may be a removable or non-removable medium and may include a machine-readable medium, such as a flash drive, magnetic disk, or any other medium, which may be capable of storing information and/or data (for example, training data for training) and may be accessed within the computing device 900.

The computing device 900 may further include an additional removable/non-removable, volatile/non-volatile storage medium. Although not shown in FIG. 9, a disk drive for reading or writing from a removable, nonvolatile magnetic disk (for example, a “floppy disk”) and an optical disk drive for reading or writing from a removable, nonvolatile optical disk may be provided. In these cases, each drive may be connected to a bus (not shown) by one or more data medium interfaces. The memory 920 may include a computer program product 925 having one or more program modules configured to perform various methods or actions of various implementations of the present disclosure.

The communication unit 940 implements communications with other computing devices over a communications medium. Additionally, the functionality of components of the computing device 900 may be implemented in a single computing cluster or multiple computing machines capable of communicating over a communication connection. Thus, the computing device 900 may operate in a networked environment using logical connections with one or more other servers, network personal computers (PCs), or another network node.

The input device 950 may be one or more input devices, such as a mouse, a keyboard, a trackball, or the like. The c 960 may be one or more output devices, such as a display, a speaker, a printer, or the like. The computing device 900 may also communicate with one or more external devices (not shown) as needed, external devices such as storage devices, display devices, or the like, communicate with one or more devices that enable a user to interact with the computing device 900, or communicate with any device (for example, a network card, a modem, or the like) that enables the computing device 900 to communicate with one or more other computing devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, there is also provided a computer program product, which is tangibly stored on a non-transitory computer-readable medium and comprises a computer-executable instruction that is executed by a processor to implement the method described above. According to example implementations of the present disclosure, there is provided a computer program product having stored thereon a computer program, which when executed by a processor, implements the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general-purpose computer, a special-purpose computer, or other programmable data processing apparatus to produce a machine, such that the instructions, which when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions which implement various aspects of the functions/acts specified in one or more blocks in the flowchart and/or block diagram.

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in one or more blocks in the flowchart and/or block diagram.

The flowchart and block diagrams in the drawings show the architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

I/We claim:

1. A method for processing a user page, comprising:
receiving a processing request represented in a natural language, the processing request being configured to perform a first action on a first page element in a group of page elements in the user page;
obtaining a repository, the repository comprising a group of actions performed on the group of page elements and an association between code data for performing the group of actions, and the group of actions comprising the first action; and
determining, based on the processing request and the repository, first code data for performing the first action on the first page element.

2. The method of claim 1, wherein obtaining the repository comprises:
obtaining original code data, the original code data being obtained by performing an action in the group of actions on a page element in the group of page elements;
determining a group of labels, a label in the group of labels being configured to indicate a code segment associated with the action in the original code data; and
generating the code data based on the original code data and the group of labels.

3. The method of claim 2, wherein the first code data comprises:
page element code for describing the user page; and
action code for describing an action in the group of actions performed on a page element in the group of page elements.

4. The method of claim 2, wherein generating the code data comprises:
constructing a first prompt, the first prompt instructs a machine learning model to process the original code data based on the group of labels, to generate the code data; and
determining the code data based on a response of the machine learning model to the first prompt.

5. The method of claim 3, wherein determining the first code data comprises:
determining a page element code corresponding to the user page; and
obtaining, from the repository, the first code data matching the page element code and the action.

6. The method of claim 5, wherein obtaining the first code data from the repository comprises:
constructing a second prompt, the second prompt instructing a machine learning model to retrieve, from the repository, code data matching the page element code and the action; and
determining the first code data based on a response of the machine learning model to the second prompt.

7. The method of claim 1, further comprising: performing the first action on the first page element based on the first code data.

8. The method of claim 7, wherein the user page comprises a first user page and a second user page, the first user page comprises the first page element, the second user page comprises a second page element, and the first page element is configured to trigger a jump from the first user page to the second user page.

9. The method of claim 8, further comprising:
in response to the first action performed on the first page element, jumping from the first user page to the second user page;
in response to determining that the processing request further requests to perform a second action on the second page element, determining, based on the processing request and the repository, second code data for performing the second action on the second page element; and
performing the second action on the second page element based on the second code data.

10. The method of claim 1, wherein the processing request is generated based on:
for a user page to be processed in a group of user pages in an application, determining a group of page elements in the user page;
determining a candidate action to be performed on a page element to be processed in the group of page elements; and
generating the processing request based on the user page to be processed, the page element to be processed, and the candidate action.

11. An electronic device, comprising:
a group of processing units; and
a group of memories coupled to the group of processing units and storing instructions for execution by the group of processing units, the instructions, when executed by the group of processing units, causing the electronic device to perform operations comprising:
receiving a processing request represented in a natural language, the processing request being configured to perform a first action on a first page element in a group of page elements in the user page;
obtaining a repository, the repository comprising a group of actions performed on the group of page elements and an association between code data for performing the group of actions, and the group of actions comprising the first action; and
determining, based on the processing request and the repository, first code data for performing the first action on the first page element.

12. The electronic device of claim 11, wherein obtaining the repository comprises:
obtaining original code data, the original code data being obtained by performing an action in the group of actions on a page element in the group of page elements;
determining a group of labels, a label in the group of labels being configured to indicate a code segment associated with the action in the original code data; and
generating the code data based on the original code data and the group of labels.

13. The electronic device of claim 12, wherein the first code data comprises:
page element code for describing the user page; and
action code for describing an action in the group of actions performed on a page element in the group of page elements.

14. The electronic device of claim 12, wherein generating the code data comprises:
constructing a first prompt, the first prompt instructs a machine learning model to process the original code data based on the group of labels, to generate the code data; and
determining the code data based on a response of the machine learning model to the first prompt.

15. The electronic device of claim 13, wherein determining the first code data comprises:
determining a page element code corresponding to the user page; and
obtaining, from the repository, the first code data matching the page element code and the action.

16. The electronic device of claim 15, wherein obtaining the first code data from the repository comprises:
constructing a second prompt, the second prompt instructing a machine learning model to retrieve, from the repository, code data matching the page element code and the action; and
determining the first code data based on a response of the machine learning model to the second prompt.

17. The electronic device of claim 11, the operations further comprising:
performing the first action on the first page element based on the first code data.

18. The electronic device of claim 17, wherein the user page comprises a first user page and a second user page, the first user page comprises the first page element, the second user page comprises a second page element, and the first page element is configured to trigger a jump from the first user page to the second user page.

19. The electronic device of claim 18, the operations further comprising:
in response to the first action performed on the first page element, jumping from the first user page to the second user page;
in response to determining that the processing request further requests to perform a second action on the second page element, determining, based on the processing request and the repository, second code data for performing the second action on the second page element; and
performing the second action on the second page element based on the second code data.

20. A non-transitory computer-readable storage medium having stored thereon a computer program which, when executed by a processor, causes the processor to perform operations comprising:
receiving a processing request represented in a natural language, the processing request being configured to perform a first action on a first page element in a group of page elements in the user page;
obtaining a repository, the repository comprising a group of actions performed on the group of page elements and an association between code data for performing the group of actions, and the group of actions comprising the first action; and
determining, based on the processing request and the repository, first code data for performing the first action on the first page element.
